(19) United States
(12) Patent Application Publication
(10) Pub. No.: US 2018/0126590 A1
(43) Pub. Date: May 10, 2018

(54) METHOD FOR FORMING ARTICLES THROUGH CASTING OR INJECTION MOLDING

(71) Applicant: General Electric Company, Schenectady, NY (US)

(72) Inventors: Edward James Balaschak, Simpsonville, SC (US); Ryan Thomas Fava, Ballston Lake, NY (US)

(21) Appl. No.: 15/346,856

(22) Filed: Nov. 9, 2016

(51) Int. Cl. B28B 17/02; B28B 1/24

(52) U.S. Cl. CPC B28B 17/026; B28B 1/24

(57) ABSTRACT

Various embodiments of the invention include a method for combining slurry components to form a solid object. Various particular embodiments include a method including: combining a first slurry component with a second slurry component to form a homogenized slurry, wherein the first slurry component includes: a catalyst, and a vinyl binder, and wherein the second slurry component includes: a siloxane binder, and wherein at least one of the first slurry component and the second slurry component includes a particulate composition; introducing the homogenized slurry into a die; and curing the homogenized slurry in the die to form the solid object.

### FIELD OF THE INVENTION

The disclosure relates generally to ceramic forming and manufacturing, and more particularly, to an apparatus and method for mixing a multi-part slurry and forming a cast object.

### BACKGROUND OF THE INVENTION

Casting includes pouring or injecting a liquid material into a mold or die to form a cast object. The object may be metal, ceramic, or plastic. A cast object may require further machining to achieve complex shapes. Complex shapes are difficult and expensive to manufacture by machining and other subtractive techniques.

One example of casting is slurry-based casting. Slurry-based casting can be used to form solid objects, i.e., solid ceramic objects, from a fluid slurry. Slurry-based casting methods are useful for manufacturing complex or delicate objects with a higher density than powder-based additive manufacturing methods. For example, slurry-based casting is useful for forming ceramic cores of turbine components such as turbine blades, nozzles, and the like. These cores are consumed in the casting process of the final metal turbine component.

One slurry-based casting method includes injecting a slurry into a die having an object manifold in the shape of a desired final object. When using a ceramic slurry, this process may be called ceramic injection molding. Current slurry-based casting methods use a slurry that must be stored at very low temperatures, i.e., between −20° F. (−29° C.) and −40° F. (−40° C.). The slurry must be kept refrigerated to remain fluid. As the temperature increases, chemical reactions cause the slurry to harden. Such refrigeration is expensive. Also, such slurries are stored, transported, and utilized in small disposable containers or cartridges. The use of the small disposable containers or cartridges is inefficient and further increases costs in both materials and labor.

### BRIEF DESCRIPTION OF THE INVENTION

A first aspect of the disclosure provides an apparatus for forming an object. The apparatus includes: at least two reservoirs for storing material components; a mixing device having an inlet and an outlet, the inlet of the mixing device being fluidly connected to the at least two reservoirs; and a die fluidly connected to the outlet of the mixing device, the die including an object manifold, wherein the mixing device and the die are a single unit detachable from the at least two reservoirs.

A second aspect of the disclosure provides an apparatus for storing slurry components and forming an object at approximately room temperature. The apparatus includes: at least two reservoirs for storing slurry components; a mixing device having an inlet and an outlet, the inlet of the mixing device being fluidly connected to the at least two reservoirs; and a die fluidly connected to the outlet of the mixing device, the die including an object manifold, wherein the mixing device and the die are a single unit detachable from the at least two reservoirs.

A third aspect of the disclosure provides a die for casting a solid object. The die includes: an object manifold having an inlet; and a mixing device having an inlet and an outlet, the outlet of the mixing device being fluidly connected to the inlet of the object manifold, and the inlet of the mixing device configured to fluidly connect to a fluid source.

A fourth aspect of the disclosure provides a method for combining slurry components to form a solid object, the method including: combining a first slurry component with a second slurry component to form a homogenized slurry, wherein the first slurry component includes: a catalyst, and a vinyl binder, and wherein the second slurry component includes: a siloxane binder, and wherein at least one of the first slurry component and the second slurry component includes a particulate composition; introducing the homogenized slurry into a die; and curing the homogenized slurry in the die to form the solid object

A fifth aspect of the disclosure provides solid object formed using a slurry-based casting method, the solid object comprising: at least a portion formed by: combining a first slurry component with a second slurry component to form a homogenized slurry, wherein the first slurry component includes: a catalyst, a vinyl binder, and wherein the second slurry component includes: a siloxane binder, and wherein at least one of the first slurry component and the second slurry component includes a particulate composition; introducing the homogenized slurry into a die; and curing the homogenized slurry in the die to form the solid object.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a schematic view of an object-forming apparatus with a die including an object manifold according to embodiments of the disclosure.

FIG. 2 shows a schematic view of an object-forming apparatus with a die including a test coupon manifold and an object manifold according to embodiments of the disclosure.

FIG. 3 shows a schematic view of an object-forming apparatus with a die including a static mixer, a test coupon manifold, and an object manifold according to embodiments of the disclosure.

FIG. 4 shows a block diagram of a method for forming a solid ceramic object according to embodiments of the disclosure.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

In the following specification and the claims, reference will be made to a number of terms which shall be defined to have the following meanings:

“Optional” or “optionally” means that the subsequently described event or circumstance may or may not occur, and that the description includes instances where the event occurs and where it does not. Optional features may or may not be present in the machine or apparatus itself, and the description includes instances where the feature is present and where it is not.

As indicated herein, the disclosure provides an apparatus and method for forming an object. The apparatus may be used to form a ceramic object, using slurry-based casting or injection molding. The apparatus may also be used to form a solid object other than a ceramic object, such as a plastic object, or a metallic object. The disclosure also provides chemical compositions of slurry components that are fluid (liquid) at approximately room temperature.

As indicated, casting includes pouring or injecting a liquid material into a mold or die to form a cast object. One type of casting is known as investment casting, where a mold is formed around fugitive wax pattern. After the wax is melted away, a liquid material, a plastic, metal, ceramic, etc., is poured into the mold and allowed to harden or cure. Today, molds may instead be additively manufactured, for example 3D printed. Additively manufactured molds can be made cheaper and more precise than typical investment casting molds, especially when the design of the mold is altered frequently, for example during testing.

As indicated, additive manufacturing (AM) includes a wide variety of processes of producing an object through the successive addition of material rather than the removal of material. As such, additive manufacturing can create complex geometries without the use of any tools, and with little or no waste material. Instead of machining objects from solid billets of material, much of which is cut away and discarded, the only material used in additive manufacturing is what is required to shape the object.

As indicated, one example of casting is slurry-based casting (also called injection molding). Slurry-based casting can be used to form solid objects, i.e., solid ceramic objects, from a fluid slurry. Slurry-based casting methods are useful for manufacturing complex or delicate objects with a higher density than powder-based additive manufacturing methods. For example, slurry-based casting is useful for forming ceramic cores of turbine components such as turbine blades, nozzles, and the like.

One slurry-based casting method includes injecting a slurry into a die having an object manifold in the shape of a desired final object. Current slurry-based casting methods use a slurry that must be stored at very low temperatures, i.e., between −20° F. (−29° C.) and −40° F. (−40° C.). The slurry must be kept refrigerated to remain fluid. As the temperature increases, chemical reactions cause the slurry to harden. Such refrigeration is expensive. Also, such slurries are stored, transported, and utilized in small disposable containers or cartridges. The use of the small disposable containers or cartridges is inefficient and further increases costs in both materials and labor.

This disclosure describes an apparatus and method for mixing slurry components that are fluid at approximately room temperature, as well as the chemical compositions of the slurry components themselves. It is possible to increase the efficiency and lower the cost of slurry-based casting because the slurry components do not require refrigeration. The slurry components can be stored in much larger containers such as tanks and vats, as opposed to the small cartridges that are currently required due to refrigeration needs. Additionally, the scaled storage capability is more efficient at least because only an amount of material necessary to form a part can be dispensed. Currently, the cartridges contain discrete amounts of slurry. If a part requires a partial cartridge, the remaining slurry in the cartridge is wasted. If a part requires more than one cartridge, the cartridge must be changed while the part is being formed. This cartridge change requires time and may even introduce unwanted disruption in slurry flow which may affect the final object.

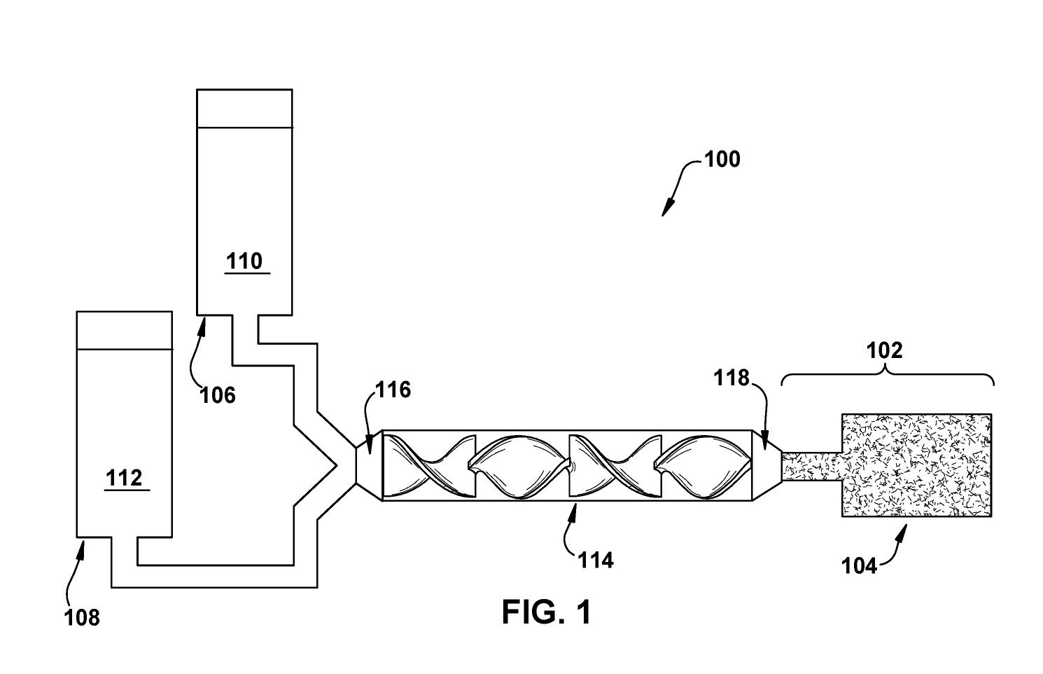

FIG. 1 shows a schematic view of an object-forming apparatus 100 with a die 102 including an object manifold 104 according to embodiments of the disclosure. Object-forming apparatus 100 may be used to homogenize at least two material components 110, 112 and inject the homogenized components into die 102. The material components 110, 112 may be injected by pumps (not shown), or any other now known or later developed means of moving or pressurizing fluid. The Figures show an embodiment of the disclosure with two material components 110, 112 for simplicity, however it is understood that object-forming apparatus 100 may include any number of material components. The Figures show one die 102 for simplicity, however it is understood that object-forming apparatus 100 may include any number of dies 102. Object-forming apparatus 100 may include at least two reservoirs 106, 108 for storing the at least two material components 110, 112. In one embodiment, first reservoir 106 contains first material component 110 and second reservoir 108 contains second material component 112. First material component 110 and second material component 112 may include any materials to be homogenized. An embodiment will be described where first and second material components 110, 112 are ceramic slurries, however first and second material components 110, 112 may include ceramic slurries, plastics, caulks, construction adhesives, metallic slurries, etc.

Object forming apparatus 100 includes a mixing device 114 having an inlet 116 and outlet 118. Inlet 116 may be fluidly connected to first reservoir 106 and second reservoir 108 by hoses, pipes, fittings, valves, or any other now know or later developed means for controlling the flow of fluid materials. Mixing device 114 may be include a static mixer, a moving mixer, or any now known or later developed means of mixing fluid materials. In one embodiment, mixing device 114 is a static mixer. Outlet 118 may be fluidly connected to die 102 (shown shaded).

Die 102 may include object manifold 104. Object manifold 104 includes a portion of die 102 that is shaped to match a desired final shape of the formed object. The homogenized material components are injected into object manifold 104 to form the object. Die 102 may be formed by machining, subtractive manufacturing, additive manufacturing, injection molding, or any now known or later developed means of forming a die 102. In one embodiment, die 102 is formed by additive manufacturing.

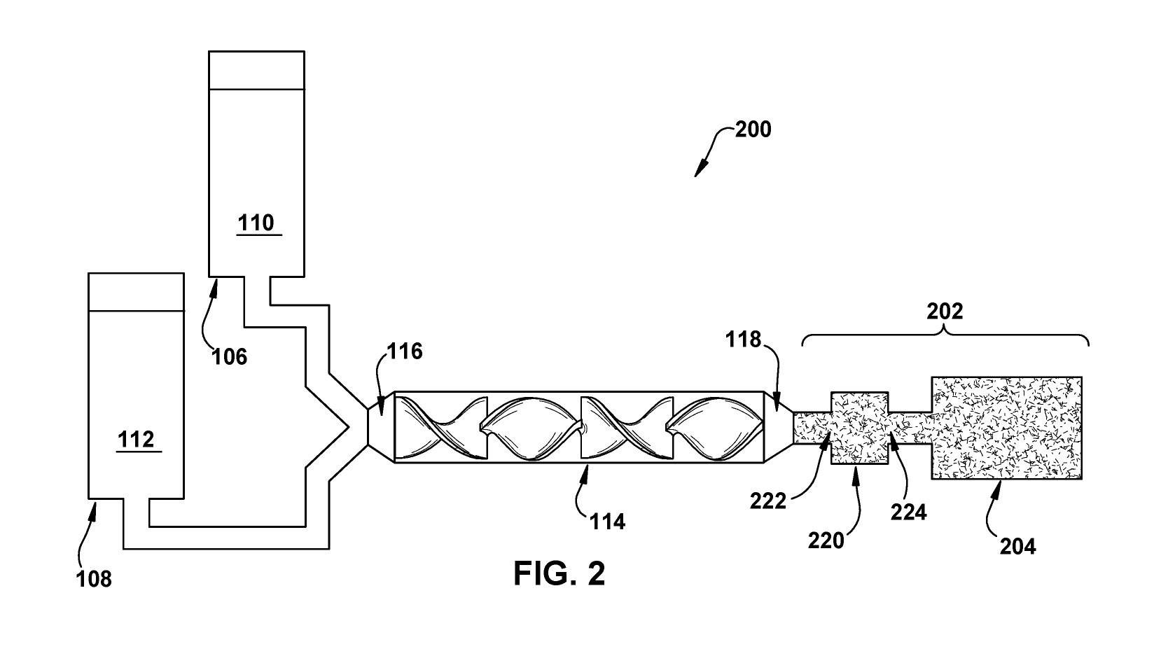

FIG. 2 shows a schematic view of an object-forming apparatus 200 with a die 202 including a test coupon manifold 220 and an object manifold 204 according to embodiments of the disclosure. In this embodiment, object manifold 204 is manufactured with test coupon manifold 220 as a single die 202 (shown shaded). In one embodiment, test coupon manifold 220 includes an inlet 222 fluidly connected to outlet 118 of mixing device 114, and an outlet 224 fluidly connected to object manifold 204. In one embodiment, test coupon manifold 220 is manufactured in die 202 such that test coupon manifold 220 will fill with homogenized components and provide a test coupon (not shown) of the same material as the formed object. Such test coupon may be submitted to materials testing to determine properties of the formed object itself.

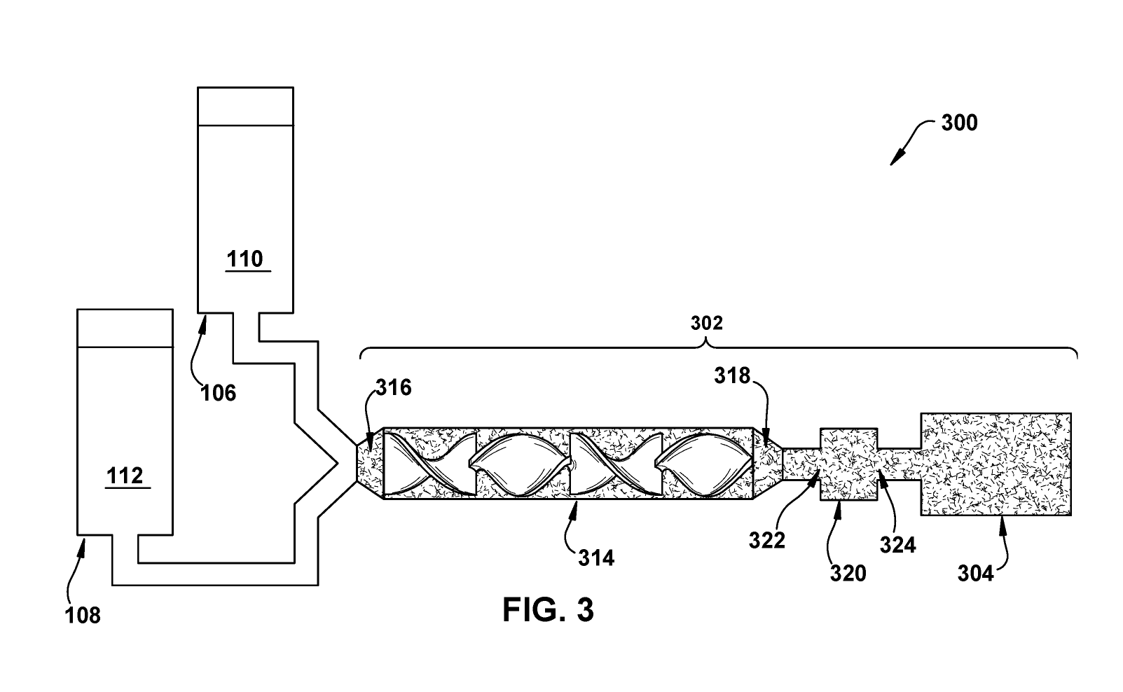

FIG. 3 shows a schematic view of an object-forming apparatus 300 with a die 302 including a static mixer 314, a test coupon manifold 320, and an object manifold 304 according to embodiments of the disclosure. In this embodiment, static mixer 314 is manufactured with object manifold 304 as a single die 302 (shown shaded). In one embodiment, an optional test coupon manifold 320 is also manufactured as part of die 302. In one embodiment, an inlet 316 of static mixer 314 is fluidly connected to first reservoir 106 and second reservoir 108 by hoses, pipes, fittings, valves, or any other now know or later developed means for controlling the flow of fluid materials. One advantage of this embodiment is increased operational up time and easier cleaning because all of the combined materials may be contained within die 302. In such an embodiment, the hardening of the materials will only occur in die 302. The other production equipment, such as first reservoir 106 and second reservoir 108 and any hoses, pipes, fitting, or valves will not include hardened material. Another advantage of this embodiment is design flexibility. In such an embodiment, a particular static mixer 314 may be selected from a plurality of mixer designs to perform best with a particular object manifold 304. The selected static mixer 314 may be manufactured as part of die 302 by machining, subtractive manufacturing, additive manufacturing, injection molding, or any now known or later developed means of forming a die.

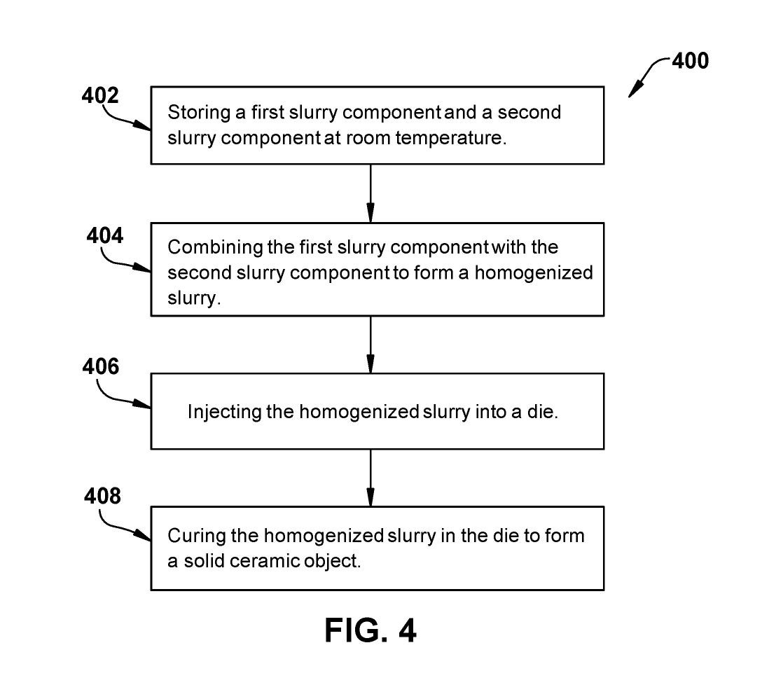

FIG. 4 shows a block diagram of a method 400 for forming a solid ceramic object according to embodiments of the disclosure. In one embodiment, first material component 110 and second material component 112 are ceramic slurry components. At block 402, first slurry component 110 is stored in first reservoir 106 at approximately room temperature. Second slurry component 112 is stored in second reservoir 108 at approximately room temperature. The chemical composition of first slurry component 110 and second slurry component 112 allow the slurry components to remain fluid at approximately room temperature.

In one embodiment, first slurry component 110 may include a silicone monomer and/or oligomer having an alkenyl functional group (a vinyl binder), and a catalyst. In one embodiment, the silicone monomer and/or oligomer having an alkenyl functional group may be selected from the group consisting of 1,3-divinyl-tetramethyldisiloxane, hexavinyldisiloxane, 1,3-divinyltetraphenyldisiloxane, 1,1,3-trivinyltrimethyldisiloxane, 1,3-tetravinyldimethyldisiloxane, 1,3,5-trivinyl-1,3,5-tri-methylcyclotrisiloxane, 1,3,5,7-tetravinyl-1,3,5,7-tetramethylcyclotetrasiloxane, 1,3-divinyloctaphenylcyclopentasiloxane, and mixtures thereof. In one embodiment, the silicone monomer and/or oligomer having an alkenyl functional group includes 1,3,5,7-tetravinyltetramethylcyclotetrasiloxane. In one embodiment, the catalyst includes a platinum catalyst. The platinum catalyst will not initiate polymerization (hardening) in the presence of the silicone monomer and/or oligomer having an alkenyl functional group.

In one embodiment, second slurry component 112 may include a silicone monomer and/or oligomer having a hydride functional group (a siloxane binder). In one embodiment, the silicone monomer and/or oligomer having a hydride functional group may be selected from the group consisting of poly(methylhydrogen)siloxane, poly[(methylhydrogen)-co-(dimethyl)]siloxane; 1,3,5,7-tetramethylcyclotetrasiloxane, 1,3,5,7,9-decamethylcyclopentasiloxane, cyclic methylhydrogen siloxanes; tetrakis(dimethylsiloxy)silane, hydridodimethylsiloxy silicate [HSi(CH₃)₂O_{1/2}]₂(SiO₂), and mixtures thereof. In one embodiment, the silicone monomer and/or oligomer having a hydride functional group may include methylhydrogenpolysiloxane. The platinum catalyst will initiate polymerization in the presence of a silicone monomer and/or oligomer having a hydride functional group. As such, polymerization (hardening) occurs when the first slurry component 110 is mixed with the second slurry component 112.

At block 404, first slurry component 110 is combined with second slurry component 112 to form a homogenized slurry. In one embodiment, at least one of the first slurry component 110 and the second slurry component includes a particulate composition. In one embodiment, the particulate composition may include a ceramic composition or a metal composition. The homogenized slurry may be a ceramic slurry. This disclosure discusses a ceramic slurry as an example, though it should be understood that the described method may be applied to other types of slurries. In one embodiment, the combining may include mixing first slurry component 110 with second slurry component 112 in a static mixer. In one embodiment, the combining may include mixing first slurry component 110 with second slurry component 112 at approximately room temperature. In one embodiment, first slurry component 110 may be combined with second slurry component 112 at a volumetric ratio ranging from 1:10 to 10:1 (first slurry component 110:second slurry component 112). In one embodiment, first slurry component 110 may be combined with second slurry component 112 at a volumetric ratio of 11:14. In another embodiment, first slurry component 110 may be combined with second slurry component 112 at a volumetric ratio of 1:1.

At block 406, the slurry is homogenized. The homogenized slurry is introduced into die 102, die 102 including an object manifold 104 in the shape of a desired final object. As discussed above, die 102 may be formed by machining, subtractive manufacturing, additive manufacturing, injection molding, or any other now know or later developed means for forming a die. As discussed above, in one embodiment, die 202 may include a test coupon manifold. As discussed above, die 302 may include a static mixer 314. In such an embodiment, the first slurry component 110 and the second slurry component 112 are introduced into die 302 which includes static mixer 314. In such an embodiment, first slurry component 110 and second slurry component 112 are injected into die 302 prior to forming a homogenized slurry. In such an embodiment, first slurry component 110 and second slurry component 112 are combined in die 302 before entering object manifold 304 or optional test coupon manifold 320. As described above, one die 102, 202, 302 is described, however it is understood that object-forming apparatus 100, 200, 300 may include any number of dies 102, 202, 302. Dies 102, 202, 302 may be filled independently, all at once, or in any combination without departing from the teachings of this disclosure.

At block 408, the homogenized slurry is allowed to cure at approximately room temperature in the die 102, 202, 302. Once first slurry component 110 and second slurry component 112 are combined into the homogenized slurry, the components undergo a chemical reaction (described later) that ultimately hardens the homogenized slurry in die 102, 202, 302. In one embodiment, curing 408 takes place at a constant temperature with storing 402 and combining 404. In one embodiment, storing 402, combining 404, and curing 408 take place at approximately room temperature. One advantage of curing homogenized slurry at approximately room temperature, compared to refrigerated slurry, is that the chemical reactions necessary to harden the homogenized slurry occur faster at warmer temperatures. Temperatures above room temperature may be used to accelerate the hardening process. In one embodiment, temperatures up to approximately 60° C. may be used to accelerate the hardening process. As such, a die 102, 202, 302 filled with approximately room temperature slurry will harden and cure faster than a die 102, 202, 302 filled with refrigerated slurry. When using approximately room temperature slurry, no additional heating or cooling is required at any step of the process.

First slurry component 110 and second slurry component 112 are stable fluids (liquids) at approximately room temperature. As stable liquids, first slurry component 110 and second slurry component 112 remain in a liquid state at approximately room temperature. First slurry component 110 and second slurry component 112 harden when homogenized to form a solid ceramic. In one embodiment, first slurry component 110 includes a catalyst, a vinyl binder, and a first portion of the ceramic composition. In one embodiment, the first portion of the ceramic composition may include a metal oxide such as silica (silicon dioxide), alumina (aluminum oxide), mullite, zircon (zirconium silicate), or the like. In one embodiment, the first portion of the ceramic composition may include silica.

Second slurry component 112 may include a siloxane binder and a second portion of the ceramic composition. The second portion of the ceramic composition may include a metal oxide such as silica (silicon dioxide), alumina (aluminum oxide), mullite, zircon (zirconium silicate), or the like. In one embodiment, the second portion of the ceramic composition may include silica. The first and second portions of the ceramic composition will vary by application, and depend on the desired ceramic composition of the final object. It should be understood that the ceramic compositions disclosed herein are only examples, and this disclosure is not limited to the example ceramic compositions described herein. One skilled in the art should realize that alternative ceramic compositions, formulaic ingredient ratios, and solids loadings may be utilized without departing from the present disclosure.

I one embodiment, first slurry component 110 includes between approximately 30% and approximately 95% ceramic composition by mass. In one embodiment, second slurry component includes between approximately 30% and approximately 95% ceramic composition by mass. In one exemplary embodiment, first slurry component 110 may include 15.744% vinyl binder by mass, 84.172% of the first portion of the ceramic composition by mass, and 0.0018% of the catalyst by mass. In the exemplary embodiment, second slurry component 112 may include 15.774% of siloxane binder by mass, and 84.373% of the second portion of the ceramic composition by mass.

It is anticipated that first slurry component 110 and second slurry component 112 may be broken up into more than two components. The slurry described above may be broken up into any number of components without departing from the present disclosure. However, the specific embodiments described above are advantageous because first slurry component 110 and second slurry component 112 are stable liquids at approximately room temperature. As explained above, there are efficiency, cost saving, and production scaling advantages to being able to store, combine, and cure the slurry components at approximately room temperature. Additionally, in the embodiments described above, first slurry component 110 and second slurry component 112 have similar viscosities. A static mixer is more effective when mixing liquids of similar viscosities.

The terminology used herein is for the purpose of describing particular embodiments only and is not intended to be limiting of the disclosure. As used herein, the singular forms “a”, “an”, and “the” are intended to include the plural forms as well, unless the context clearly indicated otherwise. It will be further understood that the terms “comprises” and/or “comprising, when used in this specification, specify the presence of stated features, integers, steps, operations, elements, and/or objects, but no not preclude the presence or addition of one or more other features, integers, steps, operations, elements, objects, and/or groups thereof.

As used in this disclosure, the term “approximately” should be interpreted as +/−10% of the value that “approximately” modifies. As used in this disclosure, “approximately room temperature” should be interpreted as a temperature that requires no heating or cooling to maintain. “Approximately room temperature,” as used in this disclosure, includes a range from 60° F. to 80° F. (about 15° C. to about 27° C.). In one embodiment, room temperature may be 70° F. (about 21° C.).

The corresponding structures, material, acts, and equivalents of all means or steps plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variation will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method for combining slurry components to form a solid object, the method comprising:
combining a first slurry component with a second slurry component to form a homogenized slurry,
wherein the first slurry component includes:
a catalyst, and
a vinyl binder, and
wherein the second slurry component includes:
a siloxane binder, and
wherein at least one of the first slurry component and the second slurry component includes a particulate composition;
introducing the homogenized slurry into a die; and
curing the homogenized slurry in the die to form the solid object.

2. The method of claim 1, further comprising storing the first slurry component at approximately room temperature in a first reservoir, and storing the second slurry component at approximately room temperature in a second reservoir.

3. The method of claim 2, wherein prior to the combining step, the first slurry component and the second slurry component are fluid and stable at approximately room temperature.

4. The method of claim 1, wherein the combining step and the curing step occur between approximately room temperature and approximately 60° C.

5. The method of claim 1, wherein the combining step includes mixing the first slurry component with the second slurry component at a volumetric ratio ranging from 1:1 to 1:10.

6. The method of claim 1, wherein the combining step includes mixing the first slurry component with the second slurry component at a volumetric ratio of 11:14.

7. The method of claim 1, wherein the particulate composition includes a ceramic composition.

8. The method of claim 7, wherein the first slurry component includes a first portion of the ceramic composition, and the second slurry component includes a second portion of the ceramic composition.

9. The method of claim 8, wherein the first slurry component includes approximately 16% of the vinyl binder by mass, approximately 84% of the first portion of the ceramic composition by mass, and approximately 0.0018% of the catalyst by mass; and wherein the second slurry component includes approximately 16% of the siloxane binder by mass, and approximately 84% of the second portion of the ceramic composition by mass.

10. The method of claim 8, wherein at least one of the first slurry component and the second slurry component includes between 30% and 95% of the ceramic composition by mass.

11. A solid object formed using a slurry-based casting method, the solid object comprising:
at least a portion formed by:
combining a first slurry component with a second slurry component to form a homogenized slurry,
wherein the first slurry component includes:
a catalyst,
a vinyl binder, and
wherein the second slurry component includes:
a siloxane binder, and
wherein at least one of the first slurry component and the second slurry component includes a particulate composition;
introducing the homogenized slurry into a die; and
curing the homogenized slurry in the die to form the solid object.

12. The solid object of claim 11, the method further comprising storing the first slurry component at approximately room temperature in a first reservoir, and storing the second slurry component at approximately room temperature in a second reservoir.

13. The solid object of claim 12, wherein prior to the combining step, the first slurry component and the second slurry component are fluid at approximately room temperature.

14. The solid object of claim 11, wherein the combining step and the curing step occur between approximately room temperature and approximately 60° C.

15. The solid object of claim 11, wherein the combining step includes mixing the first slurry component with the second slurry component at a ratio ranging from 1:1 to 1:10.

16. The solid object of claim 9, wherein the combining step includes mixing the first slurry component with the second slurry component at an 11:14 ratio.

17. The solid object of claim 11, wherein the particulate composition includes a ceramic composition.

18. The solid object of claim 17, wherein the first slurry component includes a first portion of the ceramic composition, and the second slurry component includes a second portion of the ceramic composition.

19. The solid object of claim 18, wherein the first slurry component includes approximately 16% of the vinyl binder by mass, approximately 84% of the first portion of the ceramic composition by mass, and approximately 0.0018% of the catalyst by mass; and wherein the second slurry component includes approximately 16% of the siloxane binder by mass, and approximately 84% of the second portion of the ceramic composition by mass.

20. The solid object of claim 18, wherein at least one of the first slurry component and the second slurry component includes between 30% and 95% of the ceramic composition by mass
